(19) United States
(12) Patent Application Publication
(10) Pub. No.: US 2014/0335228 A1
(43) Pub. Date: Nov. 13, 2014

(54) Pet Meal Products

(71) Applicants: Kristina Guerrero, La Pine, OR (US); Brandon Sylvester, La Pine, OR (US)

(72) Inventors: Kristina Guerrero, La Pine, OR (US); Brandon Sylvester, La Pine, OR (US)

(21) Appl. No.: 13/890,110

(22) Filed: May 8, 2013

(51) Int. Cl. A23K 1/18; A23K 1/00; A23K 1/16

(52) U.S. Cl. CPC A23K 1/18; A23K 1/1603; A23K 1/001
USPC 426/73; 426/72; 426/502

(57) ABSTRACT

A pet meal product and methods of making the pet meal product. The pet meal product including an edible bar, including a complex carbohydrate, a protein, a fat, and a multi-vitamin, wherein the edible bar provides a nutritionally complete meal. In some examples, the pet meal product further includes, an antioxidant, an omega-3 fatty acid, a flavoring compound, a coloring agent, and a texturizing agent.

### BACKGROUND

The present disclosure relates generally to pet meals. In particular, pet meal products in edible bar form are described.

Known pet meals are not entirely satisfactory for the range of applications in which they are employed. For example, existing pet meals require a large volume of food in order to satisfy daily caloric requirements of pets. The serving size requirements of existing meals dictate that large containers are required to hold and serve the meal. Often a large container, or bowl, must be filled with traditional pet food multiple times pet day to provide pets' daily caloric requirements.

Additionally, traditional pet meals are not pre-packaged in conveniently transportable serving sizes. Indeed, conventional pet meals require the inconvenient steps of selecting an appropriate container, filling that container with an adequate volume of traditional pet food to constitute a full meal, and inconveniently placing the full container in a pet accessible location.

Further, when leaving home for an extended trip, packing a sufficient volume of pet food for the excursion quickly becomes too bulky and is prohibitive due to the weight of the food. Even a short three-day weekend trip can require a volume of conventional pet food that requires a large bag or tub. Packing a large volume of traditional pet food often leads to spills and cross-contamination of pet food and other packed items.

Still further, conventional pet meals must often be supplemented with additional dietary supplements to provide complete nutrition for pets. Conventional pet meals often lack adequate vitamins and minerals. Adding supplemental nutrition, including multi-vitamins, antioxidants, and omega-3 fatty acids, to existing pet meals is necessary to provide pets with adequate nutrition on a daily basis. Purchasing separate supplemental nutritional components quickly becomes cost prohibitive.

In addition, conventional dry pet meals often require adding separate canned “wet” pet meal products to soften the texture of the dry pet meals. Traditional dry food can often be too solid for pets to chew and adequately digest. Adding canned pet food to supplement nutrition and aid in chewability and digestibility is undesirable due to the additional steps of opening separate containers and mixing the food products together, and due to the general sloppiness of “wet” mixtures.

Moreover, traditional pet meals include protein sourced from animals, which requires strict adherence to manufacturing regulations. Including animal protein in pet meals can lead to undesirable contamination, including Salmonella, E. coli, toxins and micro toxins, which can cause serious health issues for pets and people handling the pet meal products.

Thus, there exists a need for pet meal products in edible bar form that improve upon and advance the design of known pet meals. Examples of new and useful pet meal products in edible bar form relevant to the needs existing in the field are discussed below.

### SUMMARY

The present disclosure is directed to pet meal products and methods of making the pet meal products. The pet meal products including an edible bar, including a complex carbohydrate, a protein, a fat, and a multi-vitamin, wherein the edible bar provides a nutritionally complete meal. In some examples, the pet meal products further include, an antioxidant, an omega-3 fatty acid, a flavoring compound, a coloring agent, and a texturizing agent.

### BRIEF DESCRIPTION OF THE DRAWINGS

FIG. 1 is a front perspective view of a first example of a pet meal product in edible bar form depicting the pet meal packaged in clear plastic.

FIG. 2 is a side perspective view of the pet meal product shown in FIG. 1 depicting the surface texture of the bar.

FIG. 3 is a cross-section view of the pet meal product shown in FIG. 1 depicting the composition of the bar.

FIG. 4 is a rear elevation view of the pet meal product shown in FIG. 1 depicting the pet meal packaged in clear plastic.

FIG. 5 is a front perspective view of the pet meal product shown in FIG. 1, depicting three edible bars packaged in clear plastic in front of a prior art pet meal, the prior art being a clear plastic bag containing a volume of traditional pet food necessary to nutritionally equal the three edible bars.

FIG. 6 schematically depicts a method of making the pet meal product shown in FIG. 1.

### DETAILED DESCRIPTION

The disclosed pet meal products in edible bar form will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various pet meal products in edible bar form are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

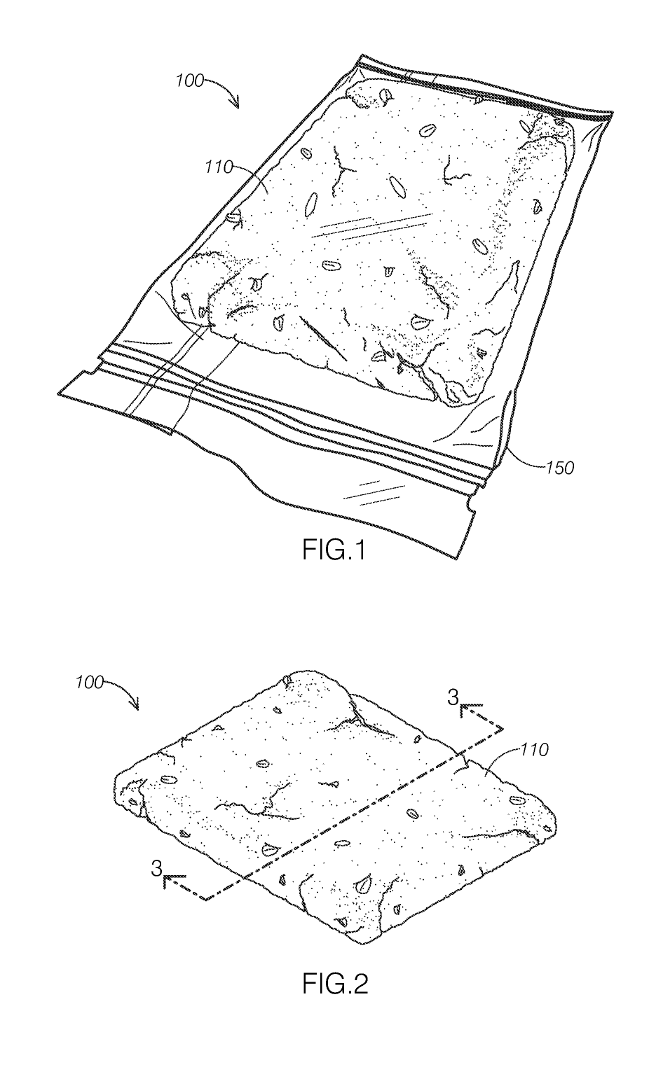

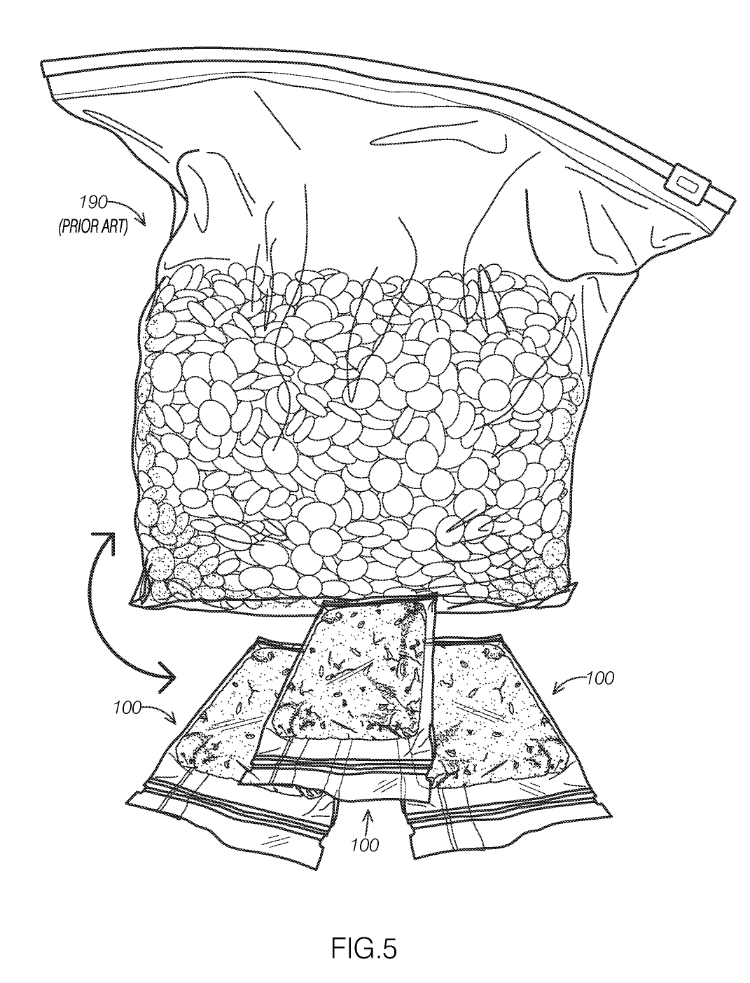

With reference to FIGS. 1-5, a first example of a pet meal product in edible bar form, edible bar 100, will now be described. Edible bar 100 includes a body 110. Edible bar 100 functions to provide complete nutrition and to satisfy daily caloric needs of pets. The size of edible bar 100 may be selected according to caloric needs of pets based on factors including, but not limited to, size, weight, and age of the pet. The preferred serving size of edible bar 100 is 125 g. Additionally or alternatively, edible bar 100 can be used to fulfill dietary needs of pets during prolonged outdoor activities and excursions.

As shown most clearly in FIGS. 1, 4, and 5, edible bar 100 may be packaged in packaging material 150. The packaging material may be comprised of any suitable material configured to selectively retain, and promote or maintain the freshness of edible bar 100. The packaging material may be comprised of biodegradable or compostable plastics or paper. Additionally or alternatively, the packaging material may be comprised of any suitable recyclable or non-recyclable packaging material including but not limited to metal, tin, aluminum foil, paper, plastic, glass, or cardboard.

Packaging material 150 is selectively re-sealable as depicted in FIGS. 1, 4, and 5. Less desirably, the packaging material may be configured to be opened once and discarded. Selectively re-sealable packaging material 150 promotes or allows selectively distributing edible bar 100 to pets.

In the preferred embodiment shown in FIG. 2, body 110 is substantially rectangular. The body may also take the form of a variety of shapes including, but not limited to, squares, triangles, stars, bones, hearts, and circles.

The surface of body 110 may be etched or imprinted with a pattern or grid lines to facilitate or allow body 110 to be divided into substantially equal or unequal portions. For example, body 110 may be etched or imprinted with grid lines to facilitate or allow body 110 to be divided in three substantially equal portions: one portion to be consumed by the pet for “breakfast,” one portion to be consumed by the pet for “lunch,” and one portion to be consumed by the pet for “dinner.”

As depicted in FIG. 2, body 110 may be flat. A flat configuration facilitates or allows multiple edible bars 100 to be conveniently stacked and packed in a small volume of space. Additionally or alternatively, body 110 may be configured in any suitable shape that facilitates or allows convenient packing within a limited volume, including, but not limited to, spherical, conical, wedge, square-block, and triangular-block.

The surface of body 110 may be etched or imprinted with a pattern or grid lines to facilitate or allow body 110 to be divided into substantially equal or unequal portions. For example when the body is in a spherical configuration, it may be etched circumferentially, both longitudinally and latitudinally, such that striking or breaking the body will form substantially equal wedge-shaped portions.

Edible bar 100 provides a nutritionally complete meal comprised of a complex carbohydrate, a protein, a fat, a multi-vitamin, and additional alternative ingredients including an antioxidant, and an omega-3 fatty acid. Edible bar 100 also includes a flavoring compound, a coloring agent, and a texturizing agent. Additionally, edible bar 100 is configured to provide a caloric content meeting or exceeding the daily caloric requirements of a pet. In the preferred embodiment, edible bar 100 is comprised of all natural ingredients. Additionally or alternatively, the edible bar may be comprised exclusively of organic, or artificial ingredients, or a combination of organic, all natural, and artificial ingredients.

One preferred nutrient composition of edible bar 100 is as follows:

TABLE 1
Nutrient Composition

| Basic Components | Per Serving |
|---|---|
| Gram Weight (g) | 125.00 |
| Calories (kcal) | 496.44 |
| Calories from Fat (kcal) | 196.56 |
| Calories form SatFat (kcal) | 30.28 |
| Protein (g) | 25.48 |
| Carbohydrates (g) | 48.83 |
| Dietary Fiber (g) | 2.49 |
| Total Sugars (g) | 1.17 |
| Other Carbs (g) | 1.45 |
| Fat (g) | 22.47 |
| Saturated Fat (g) | 3.36 |
| Mono Fat (g) | 12.83 |
| Poly Fat (g) | 5.24 |
| Cholesterol (mg) | 181.65 |
| Water (g) | 16.80 |

The complex carbohydrate may be selected from a group including, but not limited to, wheat flour, rye flour, corn flour, sweet potato flour, oats, white rice, rice bran, barley, peas, brewer's rice, egg product, garbanzo beans, and millet. Any one or a combination of these complex carbohydrates may comprise 30-60 weight percent of the edible bar. In the preferred embodiment shown in FIGS. 1-5, edible bar 100 includes complex carbohydrates comprised of brown rice flour constituting 40-45 weight percent of edible bar 100.

The protein may be selected from a group including, but not limited to, whey protein isolate, egg yolks, beef, bison, chicken, duck, lamb, salmon, turkey, egg protein powder, animal byproduct, corn gluten meal, and potato protein. Any one or a combination of these proteins may comprise 15-45 weight percent of the edible bar. In the preferred embodiment shown in FIGS. 1-5, edible bar 100 includes protein comprised of a combination of whey protein isolate (10-15 weight percent) and egg yolks (10-15 weight percent) constituting 25-30 weight percent of edible bar 100. Additionally or alternatively, whey protein isolate may comprise the sole source of protein and constitute 25-30 weight percent of the edible bar.

Further, the fat may be selected from a group including, but not limited to, olive oil, egg yolks, canola oil, grape seed oil, fowl fat, animal fat, sunflower oil, and vegetable oil. Any one or a combination of these fats may comprise 5-20 weight percent of the edible bar. In the preferred embodiment depicted in FIGS. 1-5, edible bar 100 includes fat comprised of a combination of olive oil (7-13 weight percent) and egg yolks (10-15 weight percent) constituting 17-20 weight percent of edible bar 100.

Still further, the multivitamin may be selected from a group including, but not limited to, alfalfa, glucosamine, chondroitin, probiotics, digestive enzymes, cellulose, meat and bone meal, ascorbic acid, biotin, brewers dry yeast, copper proteinate, copper sulfate, folic acid, iron proteinate, L-carnitine, acidophilus, probiotics, manganese, niacin, peas, potassium, riboflavin, sodium, taurine, thiamine, tocopherols, Vitamin A, Vitamin B12, Vitamin D, Vitamin E, and zinc. Any one or a combination of these vitamins may comprise 2-15 weight percent of the edible bar.

In the preferred embodiment shown in FIGS. 1-5 edible bar 100 includes a multi-vitamin constituted as follows:

TABLE 2
Vitamin Composition

| Vitamins | Per Serving |
|---|---|
| Vitamin A - IU (IU) | 741.23 |
| Vitamin A - RAE (RAE) | 68.81 |
| Beta-Carotene (mcg) | 223.25 |
| Vitamin B1 (mg) | 0.52 |
| Vitamin B2 (mg) | 0.32 |
| Vitamin B3 (mg) | 2.85 |
| Vitamin B3 - Niacin Equiv. (mg) | 0.84 |
| Vitamin B6 (mg) | 0.43 |
| Vitamin B12 (meg) | 3.60 |
| Biotin (mcg) | 0.02 |
| Vitamin C (mg) | 0.19 |
| Vitamin D - IU (IU) | 52.33 |
| Vitamin D - mcg (mcg) | 0.98 |
| Vitamin E - Alpha-Toco (mg) | 0.50 |
| Folate (mcg) | 11.17 |
| Folate, DFE (mcg) | 21.75 |
| Vitamin K (mcg) | 0.13 |
| Pantothenic Acid (mg) | 1.04 |

Additionally, essential minerals are included in edible bar 100 as follows:

TABLE 3
Mineral Composition

| Minerals | Per Serving |
|---|---|
| Calcium | 1259.48 |
| Copper (mg) | 0.51 |
| Iodine (mcg) | 105.02 |
| Iron (mg) | 6.31 |
| Magnesium (mg) | 87.03 |
| Manganese (mg) | 2.12 |
| Phosphorus (mg) | 1446.86 |
| Potassium (mg) | 230.79 |
| Sodium (mg) | 402.84 |
| Zinc (mg) | 9.02 |

The edible bar may also include an antioxidant from a group including, but not limited to, pomegranate concentrate, blueberry concentrate, acai concentrate, goji concentrate, cranberry concentrate, cherry concentrate, carrot, apples, peas, kelp, corn gluten meal, rosemary extract, and tomatoes. Any one or a combination of these antioxidants may comprise 1-5 weight percent of the edible bar. In edible bar 100, antioxidants comprised of pomegranate concentrate comprise 1-3 weight percent of edible bar 100.

Additionally, the edible bar may also include an omega-3 fatty acid from a group including, but not limited to, flaxseed, salmon oil, salmon, almond, almond butter, sardine, and fish oil. Any one or a combination of these omega-3 fatty acids may comprise 1-10 weight percent of the edible bar. In the preferred embodiment shown in FIGS. 1-5, edible bar 100 includes omega-3 fatty acids comprised of decosahexaeonic acid, or DHAgold™, constituting 3-7 weight percent of edible bar 100.

Further, the edible bar may also include a flavoring compound from a group including, but not limited to, natural bacon flavor, natural peanut butter, cheese, lamb, chicken, pork, sausage, salmon, fish, duck, bison, parsley, hops, and natural flavors. Any one or a combination of these flavoring compounds may comprise 1-10 weight percent of the edible bar. Edible bar 100 includes flavoring compounds comprised of natural bacon flavor constituting 1-3 weight percent of edible bar 100.

Moreover, the edible bar may also include a coloring compound from a group including, but not limited to, beet pulp, pomegranate juice, blueberry juice, acai juice, goji juice, cranberry juice, cherry juice, and tomato juice. Any one or a combination of these coloring compounds may comprise 1-10 weight percent of the edible bar. In the preferred embodiment depicted in FIGS. 1-5, edible bar 100 includes a coloring compound comprised of pomegranate juice constituting 1-3 weight percent of edible bar 100. Indeed, pomegranate juice is particularly well suited as a coloring compound when included in edible bar 100 as it provides the additional benefit of providing antioxidants as noted above.

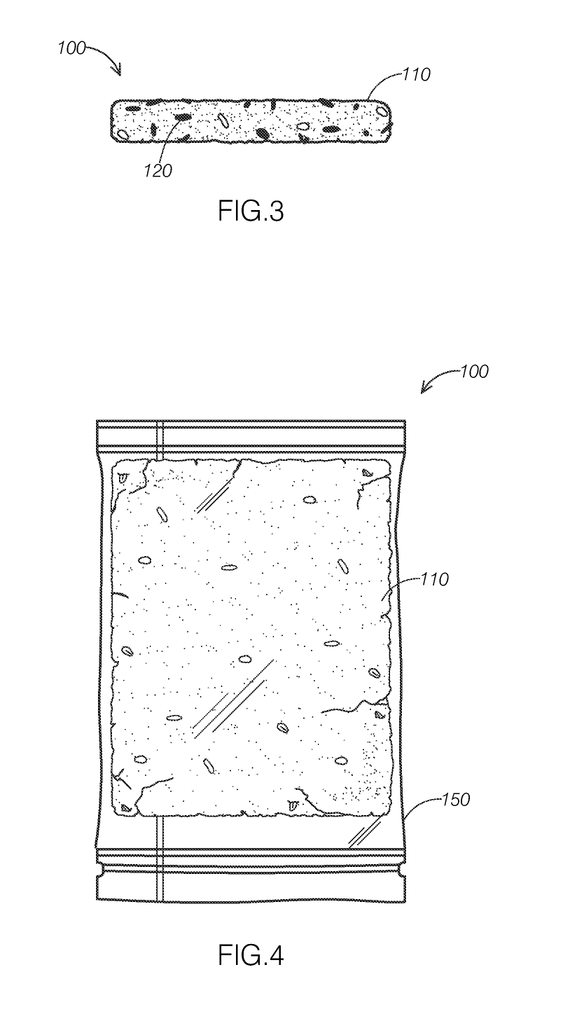

The edible bar may also include a texturizing agent from a group including, but not limited to, oats, flax seed, pumpkin, chia, psyllium, quinoa, and cous cous. Any one or a combination of these texturizing agents may comprise 1-10 weight percent of the edible bar. In the preferred embodiment depicted most clearly in FIG. 3, edible bar 100 includes texturizing agents 120 comprised of oats constituting 1-3 weight percent of edible bar 100.

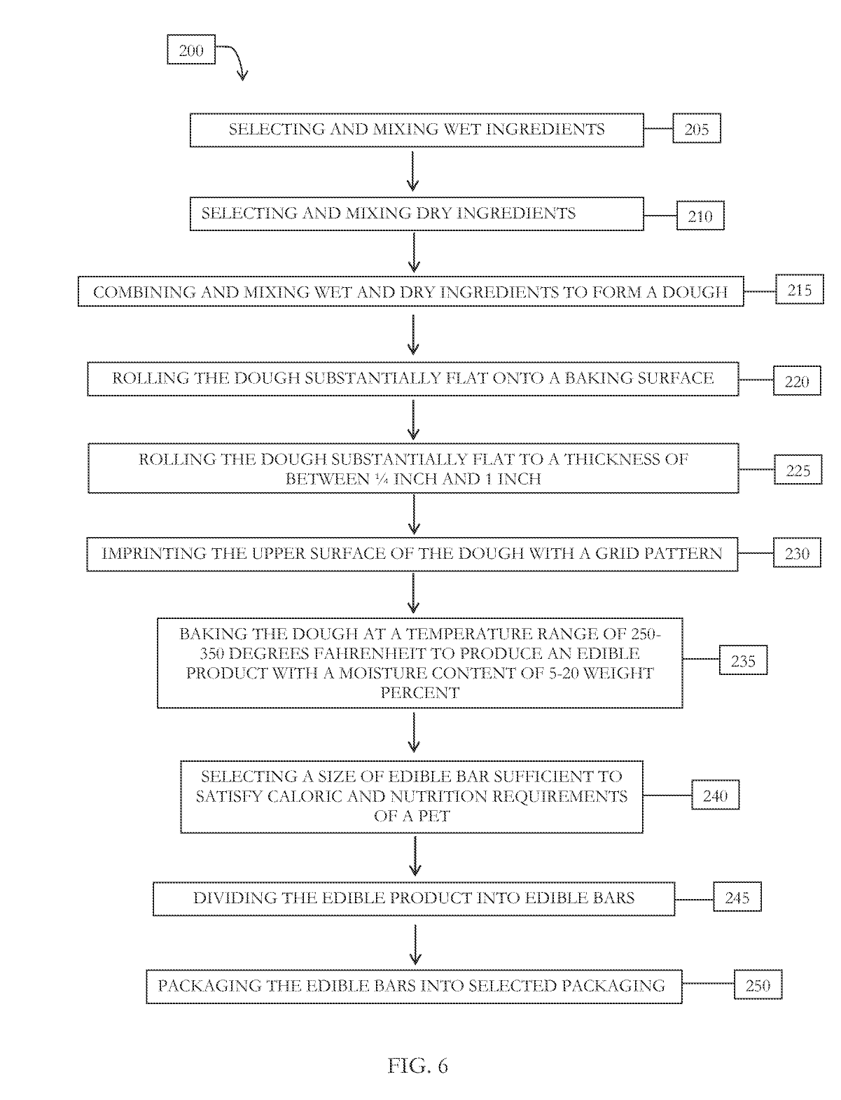

As depicted in FIG. 5, known prior art includes traditional pet food 190 in pellet or morsel form. The volume of traditional pet food 190 necessary to constitute a nutritionally complete meal is substantial. FIG. 5 depicts the volume of traditional pet food 190 necessary to provide the nutritional equivalent of three edible bars 100. The edible bars 100 depicted in FIG. 5 are sufficient to completely satisfy the nutritional and caloric requirements of a pet over a three day period. Conversely, a relatively large volume of traditional pet food 190 would be required to satisfy the nutritional and caloric requirements of the pet over the same three day period.

Turning attention to FIG. 6, a method 200 of making edible bar 100 will now be described. Method 200 includes mixing together selected wet ingredients at step 205, mixing together selected dry ingredients at step 210, combining the wet ingredients and the dry ingredients to form a dough at step 215, rolling the dough substantially flat onto a baking surface to a selected thickness at steps 220 and 225, imprinting the surface of the dough with a grid pattern at step 230, baking the dough to produce an edible product at step 235, selecting a size of edible bar at step 24), dividing the edible product into edible bars at step 245, and packaging the edible bars at step 250.

Step 205 of method 200 includes selecting wet ingredients and mixing the wet ingredients together. Wet ingredients may include but are not limited to proteins, fats, antioxidants and coloring compounds. Specifically, liquid egg yolks, olive oil, and pomegranate juice may comprise the wet ingredients. Additionally or alternatively, multi-vitamins and flavoring compounds may be mixed with the wet ingredients in step 205.

Step 210 of method 200 includes selecting dry ingredients and mixing the dry ingredients together. Dry ingredients may include, but are not limited to, carbohydrates, protein, omega-3 fatty acids, flavoring compounds, texturizing agents, and multi-vitamins. Specifically, brown rice flour, whey protein isolate, DHAgold™, bacon flavor, oats, and vitamins may comprise the dry ingredients mixed at step 210.

Next, in step 215 of method 200, the wet ingredients and dry ingredients are combined and mixed to form a dough. As noted above, one alternative is to mix the multi-vitamins and flavoring compounds with the wet ingredients before combining the wet ingredients with the dry ingredients. The wet ingredients and dry ingredients are blended to achieve a uniform dough.

Step 220 of method 200 includes rolling the dough substantially flat onto a baking surface to a selected thickness. Acceptable baking surfaces include, but are not limited, to cookie sheets, baking trays, stones, and slabs, conveyors, and wire racks.

Rolling the dough substantially flat at step 225 may include rolling the dough to a thickness between approximately ¼ inch and 1 inch. In one preferred embodiment, rolling the dough to a thickness of ½ inch at step 225 has proved particularly effective.

Alternatively, rather than rolling the dough substantially flat onto a baking surface, a baking mold may be used to form the dough into a selected shape. Examples of acceptable molds include, but are not limited to, cupcake-style cups, cake pans, pie pans, spherical, conical, and triangular.

An additional optional step, shown at step 230, is to imprint or score the surface of the dough with a pattern or grid lines to facilitate dividing the edible product after the dough is baked into an edible product. In some examples, the surface of the dough is imprinted with a substantially equal grid pattern. The grid pattern may be imprinted on the dough to facilitate or allow the baked edible product to be divided into individual edible bars. The grid pattern may further facilitate or allow the individual edible bars to be divided into smaller pre-determined caloric quantities.

Step 235 of method 200 includes baking the dough to produce an edible product. In some examples the dough may be baked at temperatures ranging from 250-350 degrees Fahrenheit. In one particular example, the temperature range is 290-300 degrees Fahrenheit. In some examples the dough is baked to achieve a moisture content between 5-20 weight percent. In one example, the dough is baked to achieve a moisture content between 10-13 weight percent.

Step 240 of method 200 includes selecting a size of edible bar sufficient to satisfy the caloric and nutrition requirements of a pet. The size of the edible bar may be selected based on factors including, but not limited to, size, weight, and age of the pet.

Step 245 of method 200 includes dividing the edible product into edible bars. In one embodiment, the edible bars are approximately ½ inch thick, rectangular in shape, and weigh approximately 125 grams.

Finally, step 250 of method 200 includes packaging the edible bars in selected packaging. Examples of suitable packaging materials include any packaging material configured to preserve moisture content and freshness of the edible bars. Acceptable packaging material may be selectively re-sealable and reusable or configured to be opened once and discarded.

Additionally or alternatively, the packaging material may be comprised of any suitable biodegradable or compostable, recyclable or non-recyclable packaging material, including, but not limited to, metal, tin, aluminum foil, paper, plastic, glass, or cardboard. In one embodiment the packaging material is comprised of compostable plastic.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicants reserve the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A pet meal product, comprising:
an edible bar, including:
a complex carbohydrate;
a protein;
a fat; and
a multi-vitamin;
wherein the edible bar provides a nutritionally complete meal.

2. The pet meal product of claim 1, wherein the edible bar further includes an antioxidant.

3. The pet meal product of claim 1, wherein the edible bar further includes an omega-3 fatty acid.

4. The pet meal product of claim 1, wherein the edible bar further includes a flavoring compound, a coloring agent, and a texturizing agent.

5. The pet meal product of claim 1, wherein the edible bar further comprises a caloric content equivalent to or exceeding a daily caloric requirement of a pet.

6. The pet meal product of claim 5, wherein the pet weighs greater than 50 pounds.

7. The pet meal product of claim 1, wherein the edible bar is comprised of natural ingredients.

8. A pet meal product, comprising:
an edible bar, including:
a complex carbohydrate from a group including brown rice flour, wheat flour, rye flour, corn flour, sweet potato flour, oats, white rice, rice bran, barley, peas, brewer's rice, egg product, garbanzo beans, millet, and combinations thereof;
a protein from a group including whey protein isolate, egg yolks, beef, bison, chicken, duck, lamb, salmon, turkey, egg protein powder, animal byproduct, corn gluten meal, potato protein, and combinations thereof;
a fat from a group including olive oil, egg yolks, canola oil, grape seed oil, fowl fat, animal fat, sunflower oil, vegetable oil, and combinations thereof;
a multi-vitamin from a group including alfalfa, glucosamine, chondroitin, probiotics, digestive enzymes, cellulose, meat and bone meal, ascorbic acid, biotin, brewers dry yeast, copper proteinate, copper sulfate, folic acid, iron proteinate, L-carnitine, acidophilus, probiotics, manganese, niacin, peas, potassium, riboflavin, sodium, taurine, thiamine, tocopherols, Vitamin A, Vitamin B12, Vitamin D, Vitamin E, zinc, and combinations thereof;
an antioxidant from a group including pomegranate concentrate, blueberry concentrate, acai concentrate, goji concentrate, cranberry concentrate, cherry concentrate, carrot, apples, peas, kelp, corn gluten meal, rosemary extract, tomatoes, and combinations thereof; and
an omega-3 fatty acid from a group including flaxseed, salmon oil, salmon, almond, almond butter, sardine, fish oil, and combinations thereof.

9. The pet meal product of claim 8, wherein the edible bar further includes a flavoring compound from a group comprised of natural bacon flavor, natural peanut butter, cheese, lamb, chicken, pork, sausage, salmon, fish, duck, bison, parsley, hops, natural flavors, and combinations thereof.

10. The pet meal product of claim 8, wherein the edible bar further includes a coloring agent from a group comprised of beet pulp, pomegranate juice, blueberry juice, acai juice, goji juice, cranberry juice, cherry juice, tomato juice, and combinations thereof.

11. The pet meal product of claim 8, wherein the edible bar further includes a texturizing agent from a group comprised of oats, flax seed, pumpkin, chia, psyllium, quinoa, cous cous, and combinations thereof.

12. The pet meal product of claim 8, wherein the edible bar includes:
30-60 weight percent complex carbohydrate,
15-45 weight percent protein,
5-20 weight percent fat,
2-15 weight percent multi-vitamins,
1-5 weight percent antioxidants, and
1-10 weight percent omega-3 fatty acids.

13. The pet meal product of claim 9, wherein the edible bar further includes:
1-10 weight percent flavoring compound,
1-10 weight percent coloring compound, and
1-10 weight percent texturizing agent.

14. The pet meal product of claim 8, wherein the edible bar is formed in a substantially rectangular shape.

15. A method of making a pet meal product, the method comprising:
mixing together selected wet ingredients suitable for pet consumption; and
mixing together selected dry ingredients suitable for pet consumption;
combining the wet ingredients and the dry ingredients to form a dough;
rolling the dough substantially flat onto a baking surface to a selected thickness;
baking the dough to produce an edible product; and
dividing the edible product into edible bars,
wherein the size of the edible bars is selected to provide the edible bars with calories and nutrition sufficient to satisfy caloric and nutrition requirements of a pet.

16. The method of making a pet meal product of claim 15, wherein the dough is rolled flat to a thickness between ¼ inch and 1 inch.

17. The method of making a pet meal product of claim 16, wherein the upper surface of the dough is imprinted with a grid pattern.

18. The method of making a pet meal product of claim 17, wherein the grid pattern is selected to facilitate dividing the edible product into edible bars and to facilitate further dividing the edible bars into smaller portions.

19. The method of making a pet meal product of claim 15, wherein the dough is baked until the moisture content of the dough is 5-20 weight percent.

20. The method of making a pet meal product of claim 15, wherein the dough is baked at a temperature range of 250-350 degrees Fahrenheit.
